(19) United States
(12) Patent Application Publication
(10) Pub. No.: US 2023/0311900 A1
(43) Pub. Date: Oct. 5, 2023

(54) DRIVING ASSISTANCE DEVICE, DRIVING ASSISTANCE METHOD, AND STORAGE MEDIUM

(71) Applicant: HONDA MOTOR CO., LTD., Tokyo (JP)

(72) Inventors: Akira Kanehara, Wako-shi (JP); Jovin Jeevan Dsa, Wako-shi (JP)

(21) Appl. No.: 18/126,508

(22) Filed: Mar. 27, 2023

(30) Foreign Application Priority Data
Mar. 31, 2022 (JP) 2022-059140

(51) Int. Cl. B60W 40/08; B60W 50/14; G06V 20/59; G06V 20/56

(52) U.S. Cl. CPC B60W 40/08; B60W 50/14; G06V 20/597; G06V 20/56; B60W 2540/225; B60W 2050/146

(57) ABSTRACT

A driving assistance device includes a processor configured to execute computer-readable instructions to perform. The processor is configured to estimating a visual line direction of a driver of a vehicle based on a rear-view image including the driver, recognizing a target included in a front-view image obtained by capturing the view in front of the vehicle, determining whether or not the target is a notification target that is a target of which the driver is notified, determining a visual recognition state indicating whether or not the driver has visually recognized the notification target based on the visual line direction, and notifying the driver of the presence of the notification target using a notification device when it is determined that the visual recognition state is a visual recognition state in which the driver has not visually recognized the notification target.

### CROSS-REFERENCE TO RELATED APPLICATION

Priority is claimed on Japanese Patent Application No. 2022-059140, filed Mar. 31, 2022, the content of which is incorporated herein by reference.

### BACKGROUND

### Field of the Invention

The present invention relates to a driving assistance device, a driving assistance method, and a storage medium.

### Description of Related Art

In the related art, technology related to an information processing device for detecting a visual line direction of a driver of a vehicle and controlling the vehicle in a safe state when the driver is not facing in a proper direction during driving is disclosed (for example, see PCT International Publication No. WO 2020/100585).

In the related art, a case where a visual line direction of a driver is blocked by a non-transparent part of a vehicle body, such as, for example, a front pillar (a so-called A-pillar) is not taken into account.

### SUMMARY OF THE INVENTION

The present invention has been made in recognition of the above-described problem and an objective of the present invention is to provide a driving assistance device, a driving assistance method, and a storage medium capable of determining a target located in a direction in which a visual line direction of a driver is blocked and providing a notification of a determination result.

A driving assistance device, a driving assistance method, and a storage medium according to the present invention adopt the following configurations.

(1): According to an aspect of the present invention, there is provided a driving assistance device including a processor configured to execute computer-readable instructions to perform: estimating a visual line direction of a driver of a vehicle based on a rear-view image including the driver; recognizing a target included in a front-view image obtained by capturing the view in front of the vehicle; determining whether or not the target is a notification target that is a target of which the driver is notified; determining a visual recognition state indicating whether or not the driver has visually recognized the notification target based on the visual line direction; and notifying the driver of the presence of the notification target using a notification device when it is determined that the visual recognition state is a visual recognition state in which the driver has not visually recognized the notification target.

(2): In the above-described aspect (1), in a state in which a visual field blockage area where a visual field of the driver is blocked by a non-transparent area that is a part of a non-transparent vehicle body provided in the vehicle is preset within the angle of view of the front-view image, the processor is configured to execute the computer-readable instructions to perform: determining that the driver has not visually recognized the notification target in a first visual recognition state in which a position where the notification target is located has not been in the visual line direction for a first period of time or longer or a second visual recognition state in which the position where the notification target is located is in a direction of the visual field blockage area and the position where the notification target is located has not been in the visual line direction for a second period of time or longer, the second period of time being longer than the first period of time.

(3): In the above-described aspect (2), the visual field blockage area is preset based on a positional relationship between the non-transparent area and the visual line direction when the driver is facing in a direction of the non-transparent area.

(4): In the above-described aspect (3), the visual field blockage area is preset based on coordinates indicating a position of a head portion of the driver and coordinates indicating a position of a center of the non-transparent area on a two-dimensional plane at an eye level of the driver.

(5): In the above-described aspect (3), the visual field blockage area is preset based on an angle between a visual line reference line indicating a visual line direction when the driver is facing forward and an end of the non-transparent area on a two-dimensional plane at an eye level of the driver.

(6): In the above-described aspect (3), the visual field blockage area is preset based on a width of the non-transparent area on a two-dimensional plane at an eye level of the driver.

(7): In the above-described aspect (2), the visual field blockage area includes at least an area of a front pillar of the vehicle by which a visual field is blocked in a driving state in which the driver is driving the vehicle.

(8): In the above-described aspect (2), the processor is configured to execute the computer-readable instructions to perform: notifying the driver of the presence of the notification target by causing the notification device to produce a sound indicating notification content.

(9): In the above-described aspect (2), the processor is configured to execute the computer-readable instructions to perform: generating a notification image indicating notification content, and notifying the driver of the presence of the notification target by causing the notification device to display the notification image.

(10): In the above-described aspect (2), the processor is configured to execute the computer-readable instructions to perform: notifying increases a notification intensity when the driver is notified of the presence of the notification target in the second visual recognition state as compared with the first visual recognition state.

(11): In the above-described aspect (1), the notification device is a terminal device used by the driver.

(12): According to an aspect of the present invention, there is provided a driving assistance method including: estimating, by a computer, a visual line direction of a driver of a vehicle based on a rear-view image including the driver; recognizing, by the computer, a target included in a front-view image obtained by capturing the view in front of the vehicle; determining, by the computer, whether or not the target is a notification target that is a target of which the driver is notified; determining, by the computer, a visual recognition state indicating whether or not the driver has visually recognized the notification target based on the visual line direction; and notifying, by the computer, the driver of the presence of the notification target using a notification device when it is determined that the visual recognition state is a visual recognition state in which the driver has not visually recognized the notification target.

(13): According to an aspect of the present invention, there is provided non-transitory computer-readable storage medium storing a program for causing a computer to: estimate a visual line direction of a driver of a vehicle based on a rear-view image including the driver, recognize a target included in a front-view image obtained by capturing the view in front of the vehicle, determine whether or not the target is a notification target that is a target of which the driver is notified, determine a visual recognition state indicating whether or not the driver has visually recognized the notification target based on the visual line direction; and notify the driver of the presence of the notification target using a notification device when it is determined that the visual recognition state is a visual recognition state in which the driver has not visually recognized the notification target.

According to the above-described aspects (1) to (13), it is possible to determine a target located in a direction in which a visual line direction of a driver is blocked and provide a notification of a determination result.

### BRIEF DESCRIPTION OF THE DRAWINGS

FIG. 1 is a diagram showing an example of a configuration and a usage environment of a driving assistance device according to an embodiment.

FIG. 2 is a diagram showing an example of a visual field blockage area set by a visual field blockage area setter.

FIG. 3 is a diagram showing an example of a relationship between a visual line direction of a driver and a visual field blockage area set by the visual field blockage area setter.

FIG. 4 is a diagram showing an example of a situation in which the driving assistance device provides a notification of the presence of a target.

FIG. 5 is a flowchart showing an example of a flow of a process executed in the driving assistance device.

FIG. 6 is a diagram showing an example of a notification image for providing a notification in the driving assistance device.

### DETAILED DESCRIPTION OF THE INVENTION

Hereinafter, embodiments of a driving assistance device, a driving assistance method, and a storage medium of the present invention will be described with reference to the drawings. As used throughout this disclosure, the singular forms “a,” “an,” and “the” include plural reference unless the context clearly dictates otherwise. Although a case where left-hand traffic regulations are applied will be described, it is only necessary to reverse the left and right when right-hand traffic regulations are applied.

### [Configuration of Driving Assistance Device]

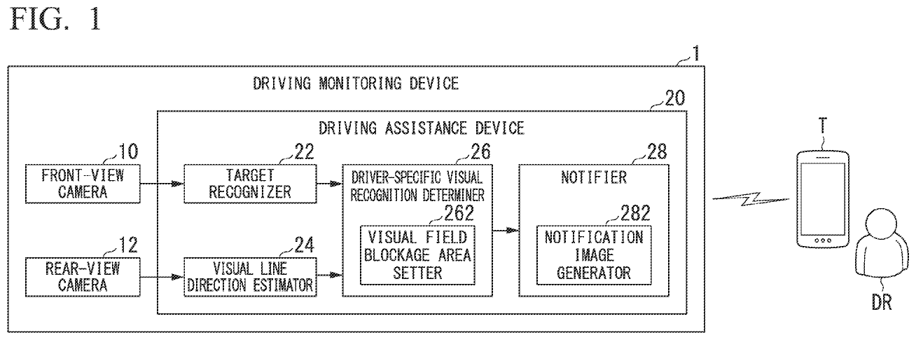

FIG. 1 is a diagram showing an example of a configuration and a usage environment of the driving assistance device according to the embodiment. The driving assistance device is mounted on a driving monitoring device 1 that is retrofitted to a vehicle (hereinafter referred to as a “vehicle V”), such as a drive recorder. The driving monitoring device 1 is attached to, for example, the glass of an upper part of a front windshield near a rearview mirror. The driving monitoring device 1 includes, for example, a front-view camera 10, a rear-view camera 12, and a driving assistance device 20. For example, the driving monitoring device 1 causes a storage device (not shown) to store images (moving images) captured by the front-view camera 10 and the rear-view camera 12. The driving monitoring device 1 includes, for example, a display device such as a liquid crystal display (LCD), and may be configured to cause the display device to display the images (the moving images) stored in the storage device.

Each of the front-view camera 10 and the rear-view camera 12 is, for example, a digital camera using a solid-state image sensor such as a charge-coupled device (CCD) or a complementary metal oxide semiconductor (CMOS). The front-view camera 10 repeatedly (periodically) images the surroundings in front of the vehicle V from a position where the driving monitoring device 1 is attached. The rear-view camera 12 repeatedly (periodically) images the surroundings behind the vehicle V from the position where the driving monitoring device 1 is attached. A horizontal angle of view at which each of the front-view camera 10 and the rear-view camera 12 performs an imaging process is 180°. That is, the driving monitoring device 1 images a range of 360° around the vehicle V from a position of its attachment.

In the image captured by the front-view camera 10 (hereinafter referred to as a “front-view image”), for example, a factor that blocks visual recognition of a target when a driver DR is in a driving state such as a part of a non-transparent vehicle body is shown as a subject in addition to a target located in front of the vehicle V seen through the front windshield or at the left/right of the vehicle V (or in front of the vehicle V) seen through the left/right window such as another vehicle, a pedestrian, a bicycle, or a fixed object. The part of the non-transparent vehicle body that blocks the driver DR from visually recognizing the target includes at least a right front pillar (a so-called A-pillar) located between the front windshield and the front of the right window and a left front pillar (a so-called A-pillar) located between the front windshield and the front of the left window. The part of the non-transparent vehicle body that blocks the driver DR from visually recognizing the target may include side mirrors (so-called door mirrors) installed outside of the vehicle in front of the left and right windows. The front-view camera 10 also outputs the captured front-view image to the driving assistance device 20.

In an image captured by the rear-view camera 12 (hereinafter referred to as a “rear-view image”), a target located inside of a cabin of the vehicle V, behind the vehicle V seen through the rear windshield, or at the left/right of the vehicle V (or behind the vehicle V) seen through the left/right window is shown. Thus, in the rear-view image captured by the rear-view camera 12, at least the driver DR of the vehicle V to which the driving monitoring device 1 is attached is also shown as a subject. The rear-view camera 12 also outputs the captured rear-view image to the driving assistance device 20.

The driving assistance device 20 notifies the driver DR of the presence of the target which cannot be visually recognized by the driver DR or whose visual recognition level by the driver DR is determined to be low through the terminal device T on the basis of the front-view image output by the front-view camera 10 and the rear-view image output by the rear-view camera 12. At this time, the driving assistance device 20 determines at least the presence or absence of a target that cannot be seen by the driver DR through the right front pillar or the left front pillar. When it is determined that there is a target that cannot be seen by the driver DR (or has a low visual recognition level), the driving assistance device 20 provides a notification to the driver DR by transmitting information indicating the presence of the target to the terminal device T.

The terminal device T is a portable terminal device used by the driver DR, who is driving the vehicle V to which the driving monitoring device 1 is attached, such as a smartphone or a tablet terminal. The terminal device T performs a procedure for receiving driving assistance from the driving assistance device 20 in accordance with an operation by the driver DR. In the terminal device T, for example, an application for receiving driving assistance from the driving assistance device 20 or the like is executed. In accordance with the operation by the driver DR, the application transmits information for setting an area that cannot be seen through the right front pillar or the left front pillar to be described below (hereinafter referred to as a “visual field blockage area”) to the driving assistance device 20. The application displays an image based on information or a notification transmitted by the driving assistance device 20 on the display device or causes the speaker to produce sounds. The terminal device T is an example of a “notification device.”

The driving assistance device 20 includes, for example, a target recognizer 22, a visual line direction estimator 24, a driver-specific visual recognition determiner 26, and a notifier 28. The driver-specific visual recognition determiner 26 includes, for example, a visual field blockage area setter 262. The notifier 28 includes, for example, a notification image generator 282.

Components provided in the driving assistance device 20 include, for example, a hardware processor such as a central processing unit (CPU) and a storage device (a storage device including a non-transitory storage medium) storing a program (software), and a function of each component is implemented when the processor executes the program. Some or all of these components provided in the driving assistance device 20 may be implemented by hardware (including a circuit; circuitry) such as a large-scale integration (LSI) circuit, an application specific integrated circuit (ASIC), a field-programmable gate array (FPGA), or a graphics processing unit (GPU) or may be implemented by software and hardware in cooperation. Some or all of the components provided in the driving assistance device 20 may be implemented using functions of components by a dedicated LSI. The program (software) may be pre-stored in a storage device (a storage device including a non-transitory storage medium) (not shown) provided in the driving assistance device 20 such as a read-only memory (ROM), a random-access memory (RAM), or a flash memory or may be stored in a removable storage medium (the non-transitory storage medium) such as a memory card and installed in the storage device when the storage medium is mounted in the driving monitoring device 1. The program (software) may be downloaded in advance from another computer device using short-range communication or wide-area communication through an application executed in the terminal device T, transmitted from the terminal device T, and installed in the storage device.

The target recognizer 22 recognizes a traveling lane in which the vehicle V is traveling on the basis of the front-view image output by the front-view camera 10. Further, the target recognizer 22 recognizes the target shown in the front-view image output by the front-view camera 10. Examples of the target recognized by the target recognizer 22 from the front-view image include other vehicles, pedestrians, bicycles, fixed objects, and the like located near the vehicle V. The other vehicles include other vehicles traveling in the same or adjacent traveling lanes and oncoming vehicles traveling in an oncoming lane. The fixed objects include fixed objects that do not move such as traffic lights installed on roads and stationary objects such as parked vehicles that are moving objects but are currently stationary such as other vehicles located in the traveling lane. The recognition of the target in the target recognizer 22 is performed in, for example, a process such as a pattern matching process using a preset target pattern to recognize a vehicle, a pedestrian, a bicycle, a fixed object, and the like. The recognition of the target in the target recognizer 22 may be performed in, for example, any deep learning process or the like. The target recognizer 22 outputs information indicating the recognized target (hereinafter referred to as “target information”) to the driver-specific visual recognition determiner 26. The target recognizer 22 recognizes the traveling lane and the target every time the front-view image is output from the front-view camera 10 and outputs the target information to the driver-specific visual recognition determiner 26. The target information includes, for example, information indicating the type of recognized target (for example, a vehicle, a pedestrian, a bicycle, a fixed object, or the like), information indicating a position where the recognized object is located (including a positional relationship with the recognized traveling lane), and the like. The target information may include, for example, a front-view image output by the front-view camera 10 and an image showing the recognized target in the front-view image. The target information may include information indicating whether the target is, for example, a moving object such as another vehicle moving at a high speed or a moving object such as a pedestrian or a bicycle moving at a low speed.

The visual line direction estimator 24 estimates the visual line direction of the driver DR on the basis of the face orientation of the driver DR shown in the rear-view image output by the rear-view camera 12. For example, information such as face orientation when the driver DR is looking at the left and right front pillars is set (registered) in the visual line direction estimator 24. The setting (registration) of the face orientation in the visual line direction estimator 24 may be performed by instructing the driver to look at the left and right front pillars through the terminal device T, for example, when the driving monitoring device 1 is attached to the vehicle V or before a current traveling process starts, and saving (storing) the rear-view image as information of the face orientation at this time. In this case, a mark (for example, a sticker) of a prescribed size may be attached to the position at the level of the visual line of the driver DR on the left and right front pillars, the driver may be instructed to look at the mark, and the rear-view image may be saved at this time. The visual line direction estimator 24 estimates the visual line direction of the driver DR by comparing information of a preset face orientation with a current face orientation of the driver DR shown in the rear-view image. The visual line direction estimator 24 outputs information indicating the estimated visual line direction of the driver DR (hereinafter referred to as “visual line information”) to the driver-specific visual recognition determiner 26. The visual line direction estimator 24 estimates the visual line direction of the driver DR every time the rear-view image is output from the rear-view camera 12 and outputs visual line information to the driver-specific visual recognition determiner 26.

The driver-specific visual recognition determiner 26 determines whether or not each target is a target which is located near the vehicle V and of which the driver DR is notified (hereinafter referred to as a “notification target”) on the basis of the target information output by the target recognizer 22. The determination of whether or not it is a notification target in the driver-specific visual recognition determiner 26 is made according to whether or not it is located in the traveling lane or is expected to enter the traveling lane. The notification target located in the traveling lane is determined on the basis of, for example, a positional relationship between a position where the recognized target is located and the recognized traveling lane included in the target information. The notification target that is expected to enter the traveling lane is determined on the basis of, for example, a change in the positional relationship between the position where the recognized target is located and the recognized traveling lane included in the target information.

Further, the driver-specific visual recognition determiner 26 determines whether or not the driver DR can visually recognize the notification target (hereinafter referred to as a “visual recognition state”) on the basis of the visual line information output by the visual line direction estimator 24. The determination of the visual recognition state in the driver-specific visual recognition determiner 26 is made according to whether or not the notification target has been in the visual line direction of the driver DR included in the visual line information for a threshold value of a prescribed period of time for determining that a human can visually recognize an object (hereinafter referred to as a “first prescribed period of time”). Further, the driver-specific visual recognition determiner 26 determines the visual recognition state of the notification target in the driver DR according to whether or not the notification target has been in the visual line direction of the driver DR for a threshold value of a prescribed period of time longer than the first prescribed period of time (hereinafter referred to as a “second prescribed period of time”) when there is a notification target in the visual field blockage area where the driver DR cannot visually recognize the target set (registered) in advance in the visual field blockage area setter 262. The visual field blockage area is, for example, an area where the driver DR cannot visually recognize the notification target due to the left and right front pillars. The visual field blockage area is set at a corresponding position within the angle of view of the front-view image captured by the front-view camera 10.

Meanwhile, a case where the position of the notification target and the visual line direction of the driver DR are moving all the time when the vehicle V is traveling is conceivable. Thus, the driver-specific visual recognition determiner 26 accumulates a period of time for which the notification target has been in the visual line direction of the driver DR from the time when the target information including the notification target has been output from the target recognizer 22. The driver-specific visual recognition determiner 26 saves (stores) the accumulated period of time in the visual line direction in, for example, a storage device (not shown). Also, the driver-specific visual recognition determiner 26 determines that the driver DR is in a state in which the notification target has not been visually recognized when the accumulated period of time is not greater than or equal to the first prescribed period of time. On the other hand, the driver-specific visual recognition determiner 26 determines that the driver DR is in a state in which the notification target has been visually recognized when the accumulated period of time is greater than or equal to the first prescribed period of time. However, when the notification target is located in the visual field blockage area as the vehicle V travels or the notification target itself moves, the driver-specific visual recognition determiner 26 determines that the driver DR is in a state in which the notification target has not been visually recognized when the accumulated period of time is not greater than or equal to the second prescribed period of time.

A state in which the notification target has not been in the visual line direction of the driver DR (a state in which it is determined that the driver DR has not visually recognized the notification target) for the first prescribed period of time or longer is an example of a “first visual recognition state.” A state in which the notification target located in the visual field blockage area has not been in the visual line direction of the driver DR (a state in which it is determined that the driver DR has not visually recognized the notification target located in the visual field blockage area) for the second prescribed period of time or longer is an example of a “second visual recognition state.”

As described above, the visual field blockage area setter 262 sets (registers) a visual field blockage area in advance. The visual field blockage area is at least an area where the driver DR cannot visually recognize the target through the left and right front pillars. The visual field blockage area may include, for example, an area where the driver DR cannot visually recognize the target through the left- and right-side mirrors. In the following description, the visual field blockage area is assumed to be an area where the driver DR cannot visually recognize the target due to the left and right front pillars. The setting (registration) of the visual field blockage area may be performed, for example, by the driver DR operating the terminal device T on which the application is executed when the driving monitoring device 1 is attached to the vehicle V or before the current traveling starts. In this case, the driving assistance device 20 can cause a display device provided in the terminal device T to display the front-view image using the application and can set (register) the visual field blockage area by performing a designation process so that an area that is shown in the front-view image but is unable to be actually visually recognized through the left and right front pillars is enclosed when the driver DR operates the terminal device T. For example, the driving assistance device 20 may automatically set (register) the visual field blockage area on the basis of positional relationships between the position where the driving monitoring device 1 is attached and the positions of the left and right front pillars shown in the front-view image. The left and right front pillars are examples of “non-transparent areas that are parts of the non-transparent vehicle body provided in the vehicle.”

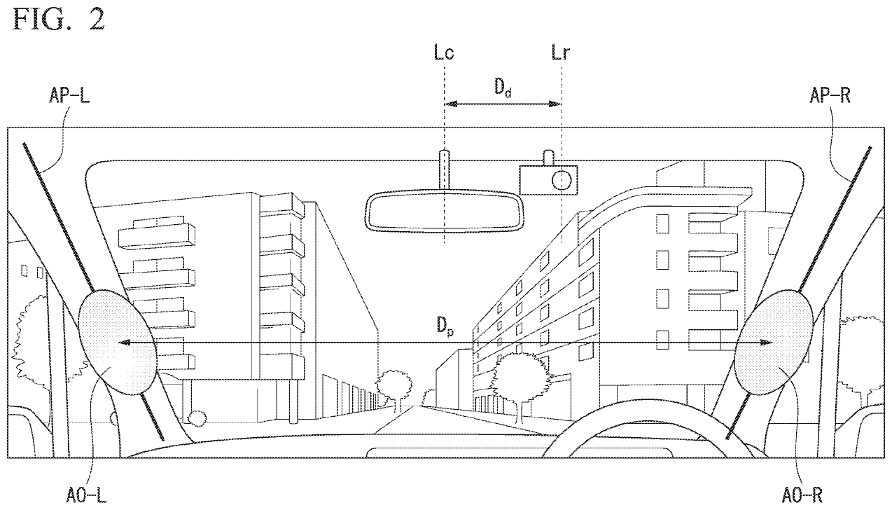

Here, an example of a method in which the visual field blockage area setter 262 automatically sets (registers) a visual field blockage area in advance in the driving assistance device 20 will be described. FIG. 2 is a diagram showing an example of a visual field blockage area set by the visual field blockage area setter 262. In FIG. 2, an example of a scenery seen from the driver DR in a state in which the driver DR is driving the vehicle V is shown. As shown in FIG. 2, the driver DR cannot visually recognize the target hidden by the shadows of the right front pillar AP-R and the left front pillar AP-L. Thus, in the driving assistance device 20, for example, a visual field blockage area AO-R having a prescribed width in which the visual field is blocked by the front pillar AP-R at the eye level of the driver DR and a visual field blockage area AO-L having a prescribed width in which the visual field is blocked by the front pillar AP-L are set (registered) in advance by the visual field blockage area setter 262. Thus, in the driving assistance device 20, an area within the front-view image corresponding to each visual field blockage area is obtained using a center line Lc in the left and right directions of the vehicle V, a center line Lr in the left and right directions at the angle of view of the front-view camera 10, an offset distance D_{d} between the center line Lc and the center line Lr, a distance Dₚ between the left and right front pillars, and the like and the visual field blockage area AO-R and the visual field blockage area AO-L are set by the visual field blockage area setter 262 in the obtained area. The distance D_{d} may be input, for example, by the driver DR operating the terminal device T on which the application is executed when the driving monitoring device 1 is attached to the vehicle V or may be set as a standard distance when a range where the driving monitoring device 1 is attached may be defined in advance and the driving monitoring device 1 is attached in the defined range. For example, the distance Dₚ may be input by the driver DR operating the terminal device T, for example, like the distance D_{d}, or may be obtained by the visual field blockage area setter 262 on the basis of a size of a left/right mark shown in a front-view image or a position within an angle of view in a state in which a mark (for example, a sticker) of a prescribed size is affixed to the position of the level of the visual line of the driver DR in the left and right front pillars when the driving monitoring device 1 is attached to the vehicle V. The visual field blockage area AO-R and the visual field blockage area AO-L are set at corresponding positions within the angle of view of the front-view image captured by the front-view camera 10. The width of each of the visual field blockage area AO-R and the visual field blockage area AO-L may be wider than the width of the area where the visual field of the driver DR is actually blocked.

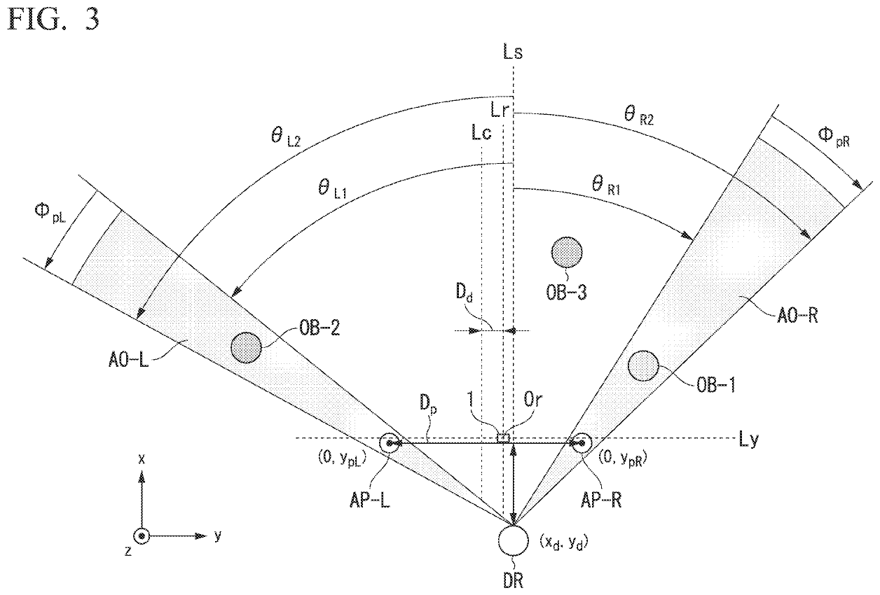

FIG. 3 is a diagram showing an example of a relationship between the visual line direction of the driver DR and the visual field blockage area set by the visual field blockage area setter 262. In FIG. 3, a bird's-eye view of an example of the relationship between the visual line direction of the driver DR and the visual field blockage area is shown. More specifically, in FIG. 3, an example of a positional relationship of the driver DR, the front pillar AP-R, the front pillar AP-L, and targets OB (here, targets OB-1 to OB-3) obtained using a position of an intersection between a reference line Ly in a y-direction and the center line Lc in a two-dimensional plane (a yz-plane) of the front-view image captured by the front-view camera 10 as a reference point Or of the driving monitoring device 1 on the two-dimensional plane (an xy-plane) at the eye level of the driver DR is shown. Here, the driver DR is a subject shown in the rear-view image and the front pillar AP-R, the front pillar AP-L, and the targets OB-1 to OB-3 are subjects shown in the front-view image.

The visual field blockage area setter 262 obtains a start angle O_{R1} and an end angle O_{R2} of the visual field blockage area AO-R and a start angle O_{L1} and an end angle O_{L2} of the visual field blockage area AO-L based on the center line Lr by expressing the positions of the driver DR, the front pillar AP-R, and the front pillar AP-L in an xy coordinate system using the reference point Or as the origin. The visual field blockage area setter 262 sets the visual field blockage area AO-R and the visual field blockage area AO-L of the left and right front pillars on the basis of the obtained angles.

At this time, the visual field blockage area setter 262 first obtains coordinates (x_{d}, y_{d}) indicating the position of the head of the driver DR. More specifically, the visual field blockage area setter 262 obtains a center position between both eyes of the driver DR, i.e., coordinates (x_{d}, y_{d}) indicating the viewpoint of the driver DR, on the basis of, for example, an arrangement position difference between the front-view camera 10 and the rear-view camera 12 in the driving monitoring device 1 and the position of the face of the driver DR shown in the rear image output by the rear-view camera 12. Also, the visual field blockage area setter 262 sets a line extending parallel to the center line Lr from the coordinates (x_{d}, y_{d}) as a reference line (hereinafter referred to as “visual line reference line”) Ls indicating a visual line direction when the driver DR is facing forward.

Further, the visual field blockage area setter 262 regards the front pillar AP-R and the front pillar AP-L as being on a two-dimensional plane (a yz-plane) that is the same as that of the front image and obtains coordinates (0, y_{pR}) indicating a position of an intersection between the reference line Ly and the center position of the front pillar AP-R and coordinates (0, y_{pL}) indicating a position of an intersection between the reference line Ly and the center position of the front pillar AP-L. Here, the coordinates y_{pR} and y_{pL} in the y-direction at the coordinates (0, y_{pR}) and coordinates (0, y_{pL}) can be obtained by transmitting an instruction to the terminal device T so that the driver DR looks at the left and right front pillars and calculating a yaw angle of the visual line direction for the coordinate system of the front-view image from the face orientation of the driver DR shown in the rear-view image at that time (wherein the rear-view image may be a rear-view image obtained by an instruction when the face orientation is set (registered) by the visual line direction estimator 24). When the distance Dₚ and the distance D_{d} are already obtained, the coordinate y_{pR} and the coordinate y_{pL} can be obtained using the following Equation (1) and the following Equation (2).

$${y}_{pR} = \frac{{D}_{p}}{2} - {D}_{d} \qquad ( 1 )$$

$${y}_{pL} = \frac{{D}_{p}}{2} + {D}_{d} \qquad ( 2 )$$

In the above Equations (1) and (2), it is assumed that y-direction coordinates in the center line Lr and the visual line reference line Ls indicating the visual line direction when the driver DR is facing forward are the same, i.e., the distance between the center line Lr and the visual line reference line Ls is Distance=0. However, when y-direction coordinates in the center line Lr and the visual line reference line Ls are different, it is only necessary to further apply a distance between the center line Lr and the visual line reference line Ls to the above Equation (1) and the above Equation (2). More specifically, it is only necessary to further subtract a distance between the center line Lr and the visual line reference line Ls from the result of the above Equation (1) and to further add a distance between the center line Lr and the visual line reference line Ls to the result of the above Equation (2).

Also, the visual field blockage area setter 262 obtains the range of the visual field blockage area AO-R (an angle Φ_{pR}) and the range of the visual field blockage area AO-L (an angle Φ_{pL}) using the coordinates (x_{d}, y_{d}) of the viewpoint of the driver DR as the center along with the thickness (width) of the corresponding front pillar with respect to each of the obtained coordinates (0, y_{pR}) and (0, y_{pL}). For example, when the width of the front pillar has been set as a width Wₚ, the visual field blockage area setter 262 obtains the angle Φ_{pR} of the visual field blockage area AO-R according to the following Equation (3) and obtains the angle Φ_{pL} of the visual field blockage area AO-L according to the following Equation (4).

$${Φ}_{pR} = {tan}^{- 1} ( \frac{\frac{1}{2} \cdot {W}_{p}}{\sqrt{{{x}_{d}}^{2} + {( {y}_{pR} - {y}_{d} )}^{2}}} ) \qquad ( 3 )$$

$${Φ}_{pL} = {tan}^{- 1} ( \frac{\frac{1}{2} \cdot {W}_{p}}{\sqrt{{{x}_{d}}^{2} + {( {y}_{pL} - {y}_{d} )}^{2}}} ) \qquad ( 4 )$$

Here, the width Wₚ of the front pillar may be a standard value (a fixed value) in a general front pillar or may be set as a value input by the driver DR operating the terminal device T like the distance D_{d} and the distance Dₚ. Further, the visual field blockage area setter 262 may obtain the width Wₚ of the front pillar by calculating a yaw angle of the visual line direction for a coordinate system of the front image with reference to the face orientation of the driver DR shown in the rear-view image (which may be a rear-view image obtained by an instruction when the visual line direction estimator 24 sets (registers) the face orientation), a size of a left/right mark shown in the front-view image, or a distance within an angle of view like the coordinates y_{pR} and the coordinates y_{pL}.

Here, for example, on the front pillar AP-R side shown in FIG. 3, the angle Φ_{pR} of the visual field blockage area AO-R can be expressed as shown in the following Equation (5) from the angle θ_{R1} between the visual line reference line Ls and the end of the rear side (the front side of the vehicle V) of the front pillar AP-R and the angle θ_{R2} between the visual line reference line Ls and the end of the front side (the rear side of the vehicle V) of the front pillar AP-R. Furthermore, a relationship between the angle θ_{R1} and the angle θ_{R2} can be expressed from the coordinates (x_{d}, y_{d}) of the viewpoint of the driver DR and the coordinates (0, y_{pR}) of the front pillar AP-R as shown in the following Equation (6).

$${θ}_{R 2} - {θ}_{R 1} = {Φ}_{pR} \qquad ( 5 )$$

$${θ}_{R 2} + {θ}_{R 1} = 2 \times {tan}^{- 1} ( \frac{{x}_{d}}{{y}_{pR} - {y}_{d}} ) \qquad ( 6 )$$

From this, the visual field blockage area setter 262 may be configured to obtain the angle θ_{R1} or the angle θ_{R2} on the basis of the front-view image and obtain the angle Φ_{pR} of the visual field blockage area AO-R by performing an inverse calculation process from the angle θ_{R1} expressed as shown in the following Equation (7) or performing an inverse calculation process from the angle θ_{R2} expressed as shown in the following Equation (8).

$${θ}_{R 1} = {tan}^{- 1} ( \frac{{x}_{d}}{{y}_{pR} - {y}_{d}} ) - \frac{1}{2} {Φ}_{pR} \qquad ( 7 )$$

$${θ}_{R 2} = {tan}^{- 1} ( \frac{{x}_{d}}{{y}_{pR} - {y}_{d}} ) + \frac{1}{2} {Φ}_{pR} \qquad ( 8 )$$

Also, on the front pillar AP-L side, relationships of the above Equations (5) to (8) can be similarly expressed by inverting the left and right. Thus, the visual field blockage area setter 262 can obtain the angle Φ_{pL} of the visual field blockage area AO-L on the basis of relationships similar to those of the above Equations (5) to (8).

In this way, the visual field blockage area AO-R and the visual field blockage area AO-L are set (registered) in advance by the visual field blockage area setter 262. Also, the driver-specific visual recognition determiner 26 determines the visual recognition state of the notification target in the driver DR using a different prescribed period of time according to whether or not the notification target is located in the visual field blockage area. That is, the driver-specific visual recognition determiner 26 determines the visual recognition state of the notification target in the driver DR according to whether or not the accumulated period of time for which the notification target that is not located in the visual field blockage area has been in the visual line direction is greater than or equal to the first prescribed period of time and determines the visual recognition state of the notification target in the driver DR according to whether or not the accumulated period of time for which the notification target located in the visual field blockage area has been in the visual line direction is greater than or equal to the second prescribed period of time. In the example shown in FIG. 3, for each of the target OB-1 located inside of the visual field blockage area AO-R and the target OB-2 located inside of the visual field blockage area AO-L, the visual recognition state of the notification target in the driver DR for the second prescribed period of time is determined. On the other hand, in the example shown in FIG. 3, for the target OB-3 located inside of the area between the visual field blockage area AO-R and the visual field blockage area AO-L (the area in front of the vehicle V), the visual recognition state of the notification target in the driver DR for the first prescribed period of time is determined.

The driver-specific visual recognition determiner 26 outputs information indicating the visual recognition state of the driver DR (hereinafter referred to as “visual recognition information”) for each notification target to the notifier 28. The visual recognition information includes, for example, information indicating the type of notification target (for example, a vehicle, a pedestrian, a bicycle, a fixed object, or the like), information indicating a position where the notification target is located (wherein the information may be information indicating whether the notification target is located inside of the visual field blockage area or outside of the visual field blockage area), information indicating the visual recognition state of the notification target in the driver DR, and the like with respect to the notification target that the driver DR cannot visually recognize or has a low visual recognition degree.

Returning to FIG. 1, the notifier 28 notifies the driver DR of the presence of a notification target that cannot be visually recognized by the driver DR or has a low visual recognition level on the basis of the visual recognition information output by the driver-specific visual recognition determiner 26. The notifier 28 generates information indicating notification content to be provided to the driver DR. The notifier 28 generates sound information for causing a sound output device such as a speaker provided in the terminal device T to produce or utter a notification sound and a voice message (for example, “a pedestrian is hidden at the end of the left front pillar” or the like) and causes the generated sound information to be pronounced or uttered by transmitting the generated sound information to the terminal device T. Thereby, the driver DR can know that there is a target (a notification target) that needs to be recognized as a risk when a traveling process of the vehicle V continues.

The notification image generator 282 generates a notification image for notifying the driver DR of the presence of a notification target that cannot be visually recognized by the driver DR or has a low visual recognition level on the basis of the visual recognition information output by the driver-specific visual recognition determiner 26. The notifier 28 transmits the notification image generated by the notification image generator 282 to the terminal device T and causes the display device provided in the terminal device T to display the notification image. Thereby, the driver DR can visually know that there is a target (a notification target) that needs to be recognized as a risk when a traveling process of the vehicle V continues.

When a notification target that cannot be visually recognized by the driver DR or has a low visual recognition level is located inside of the visual field blockage area, the notifier 28 provides a notification to the driver DR by increasing an intensity at which the notification is provided (hereinafter referred to as a “notification intensity”) than when the notification target is located outside of the visual field blockage area. The term “increasing the notification intensity” indicates that the driver DR can recognize the presence of the notification target as a target having a higher risk. At this time, the notifier 28 may change a notification method for the driver DR to increase the notification intensity. For example, when the notification intensity is increased, the notifier 28 may cause the pitch of the notification sound to be produced by the sound output device provided in the terminal device T to be higher than the pitch of the notification sound to be produced at the time of the normal notification intensity when the notification target is located outside of the visual field blockage area. For example, the notifier 28 may cause the notification image generator 282 to generate a notification image of a color indicating a higher risk. For example, when the notification intensity is increased, the notifier 28 may display a notification image along with pronunciation and utterance by the sound output device. Thereby, the driver DR can know that there is a target (a notification target) that needs to be recognized as a higher risk when a traveling process of the vehicle V continues.

Although a configuration in which the driving assistance device 20 includes the notifier 28 is shown in the example shown in FIG. 1, a configuration in which the notification of the presence of a target (a notification target) for the driver DR is provided by, for example, an application executed in the terminal device T may be adopted. In this configuration, the driver-specific visual recognition determiner 26 transmits visual recognition information to the terminal device T and the application implements the functions of the notifier 28 and the notification image generator 282. Thus, the notifier 28 and the notification image generator 282 may be omitted from the driving assistance device 20.

As described above, in the driving monitoring device 1, the driving assistance device 20 determines the presence or absence of a notification target (a target) that cannot be visually recognized by the driver DR or has a low visual recognition level on the basis of the front-view image output by the front-view camera 10 and the rear-view image output by the rear-view camera 12. Also, in the driving monitoring device 1, when it is determined that there is a notification target that cannot be visually recognized by the driver DR (or has a low visual recognition level), the driving assistance device 20 provides the notification of the presence of the notification target to the driver DR through the terminal device T. Thereby, even if the driving assistance device 20 is not incorporated in the vehicle V, i.e., even if the driving assistance device 20 is attached to the vehicle V as a retrofit, the driving monitoring device 1 can notify the driver DR of the presence of the notification target (the target) that is likely to be a risk to the continuation of the traveling process of the vehicle V by determining the visual recognition state of the notification target (the target) in the driver DR. Thereby, the driver DR of the vehicle V to which the driving monitoring device 1 is retrofitted can perform an operation (driving) of the vehicle V corresponding to the notified target or preparation thereof in advance and can continue traveling more safely.

[Example of Situation in which Notification of Presence of Notification Target is Provided]

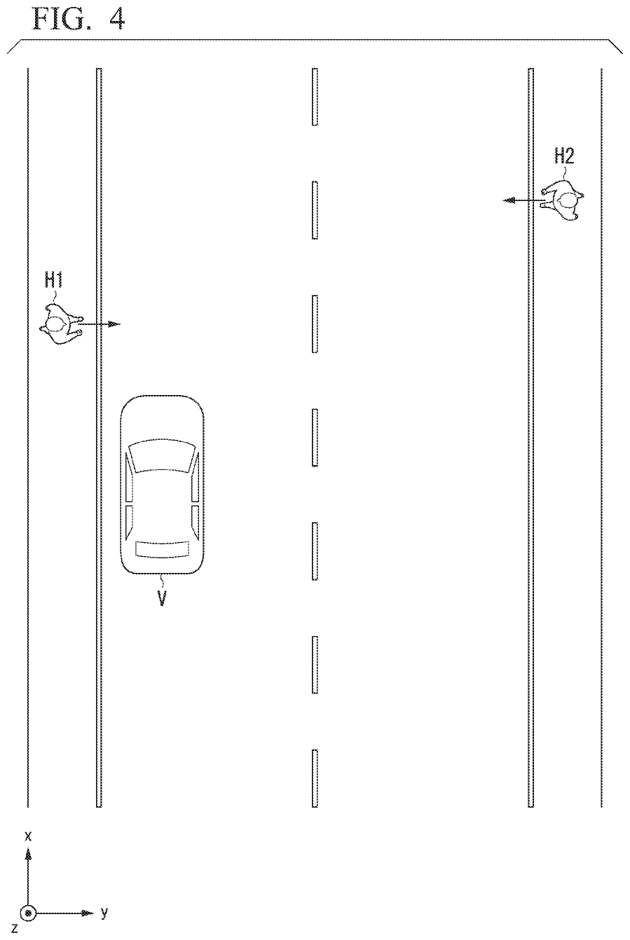

FIG. 4 is a diagram showing an example of a situation in which the driving assistance device 20 provides a notification of the presence of a target (a notification target). FIG. 4 is an example of a case where there is a possibility that a pedestrian H1 walking on the sidewalk on the shoulder side of the traveling lane in which the vehicle V is traveling will try to cross a road with two-lane, two-way traffic and a pedestrian H2 walking on the sidewalk on the opposite lane side will try to cross the road. In this case, the target recognizer 22 recognizes each of the pedestrian H1 and the pedestrian H2 as a target on the basis of the front-view image output by the front-view camera 10 and outputs target information corresponding to each of the pedestrian H1 and the pedestrian H2 to the driver-specific visual recognition determiner 26. On the other hand, the visual line direction estimator 24 estimates the visual line direction of the driver DR on the basis of the face orientation of the driver DR shown in the rear-view image output by the rear-view camera 12 and outputs visual line information to the driver-specific visual recognition determiner 26.

Here, it is assumed that the driver-specific visual recognition determiner 26 determines that each of the pedestrian H1 and the pedestrian H2 is a notification target. When the accumulated period of time for which each of the pedestrian H1 and the pedestrian H2 has been in the visual line direction of the driver DR is greater than or equal to the first prescribed period of time, the driver-specific visual recognition determiner 26 determines that the driver DR has visually recognized each of the pedestrian H1 and the pedestrian H2. On the other hand, when the accumulated period of time for which one or both of the pedestrian H1 and the pedestrian H2 have been in the visual line direction of the driver DR is less than the first prescribed period of time, the driver-specific visual recognition determiner 26 determines that the driver DR has not visually recognized the pedestrian H and outputs visual recognition information corresponding to the pedestrian H to the notifier 28. Thereby, the notifier 28 notifies the driver DR of the presence of the pedestrian H indicated in the visual recognition information output by the driver-specific visual recognition determiner 26. Here, the notifier 28 notifies the driver DR of the presence of the pedestrian H at a normal notification intensity when the pedestrian H is located outside of the visual field blockage area.

Thereafter, when one or both of the pedestrian H1 and the pedestrian H2 have been located inside of the visual field blockage area due to the movement of the vehicle V or the movement of the pedestrian H1 or/and the pedestrian H2, the driver-specific visual recognition determiner 26 determines that the driver DR has visually recognized the pedestrian H located inside of the visual field blockage area when the accumulated period of time for which the pedestrian H has been in the visual line direction of the driver DR is greater than or equal to the second prescribed period of time. On the other hand, when the accumulated period of time for which the pedestrian H located inside of the visual field blockage area has been in the visual line direction of the driver DR is less than the second prescribed period of time, the driver-specific visual recognition determiner 26 determines that the driver DR has not visually recognized the pedestrian H and outputs the visual recognition information corresponding to the pedestrian H to the notifier 28. At this time, the visual recognition information output by the driver-specific visual recognition determiner 26 to the notifier 28 also includes information indicating that the pedestrian H is located inside of the visual field blockage area. Thereby, the notifier 28 notifies the driver DR of the presence of the pedestrian H indicated in the visual recognition information output by the driver-specific visual recognition determiner 26 with a higher notification intensity than usual.

### [Example of Process of Driving Assistance Device]

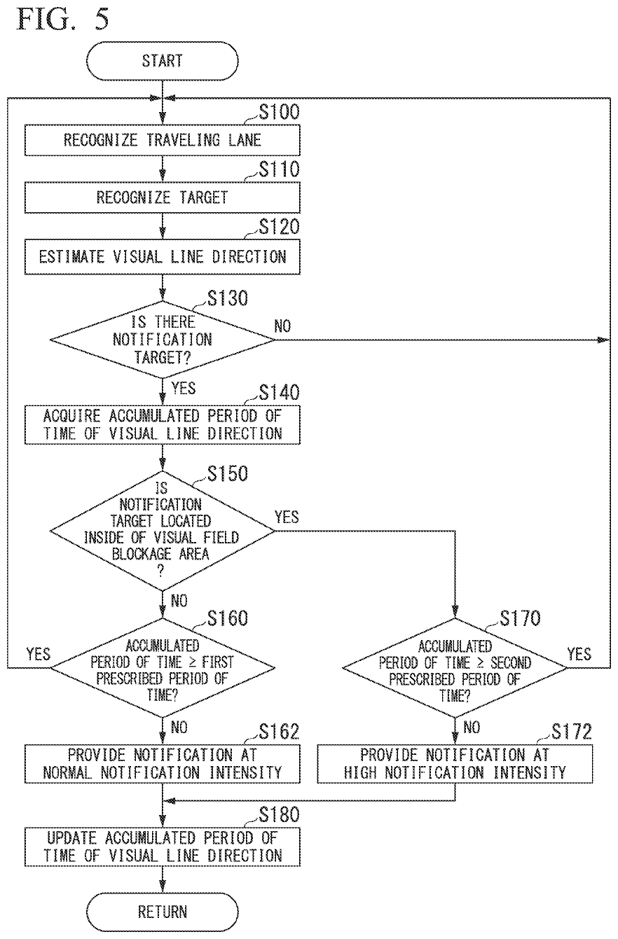

FIG. 5 is a flowchart showing an example of a flow of a process executed in the driving assistance device 20. The process of the present flowchart is iteratively executed at each prescribed time interval in which the front-view camera 10 captures a front-view image. In the process of the present flowchart, it is assumed that the rear-view camera 12 captures the rear-view image at a time interval that is the same as the prescribed time interval in which the front-view camera 10 captures the front-view image. In the following description, for ease of description, it is assumed that only one target is shown in the front-view image captured by the front-view camera 10. For example, in an example of the situation shown in FIG. 4, it is assumed that only the pedestrian H1 is shown in the front-view image. Also, it is assumed that the driver-specific visual recognition determiner 26 determines the visual recognition state of the driver DR with respect to the pedestrian H1. Here, it is assumed that the visual field blockage area setter 262 provided in the driver-specific visual recognition determiner 26 has already set (registered) the visual field blockage area.

When the front-view camera 10 captures a front-view image, the target recognizer 22 recognizes a traveling lane in which the vehicle V is traveling on the basis of the front-view image output by the front-view camera 10 (step S100). Further, the target recognizer 22 recognizes the target shown in the front-view image output by the front-view camera 10 (step S110). The target recognizer 22 outputs target information indicating the recognized target to the driver-specific visual recognition determiner 26.

The visual line direction estimator 24 estimates the visual line direction of the driver DR on the basis of the face orientation of the driver DR shown in the rear-view image output by the rear-view camera 12 (step S120). The visual line direction estimator 24 outputs visual line information indicating the estimated visual line direction of the driver DR to the driver-specific visual recognition determiner 26.

The driver-specific visual recognition determiner 26 determines whether or not there is a notification target of which the driver DR is notified on the basis of the target information output by the target recognizer 22 (step S130). When it is determined that there is no notification target (or that the target indicated in the target information is not a notification target) in step S130, the driver-specific visual recognition determiner 26 returns the process to step S100.

On the other hand, when it is determined that there is a notification target (or that the target indicated in the target information is a notification target) in step S130, the driver-specific visual recognition determiner 26 acquires an accumulated period of time for which the notification target has been in the visual line direction of the driver DR (step S140). Subsequently, the driver-specific visual recognition determiner 26 determines whether or not the notification target is located inside of the visual field blockage area (step S150).

When it is determined that the notification target is not located inside of the visual field blockage area in step S150, the driver-specific visual recognition determiner 26 confirms whether or not the accumulated period of time is greater than or equal to the first prescribed period of time (step S160). When it is confirmed that the accumulated period of time is greater than or equal to the first prescribed period of time in step S160, the driver-specific visual recognition determiner 26 determines that the driver DR has visually recognized the notification target and returns the process to step S100. On the other hand, when it is confirmed that the accumulated period of time is not greater than or equal to the first prescribed period of time in step S160, the driver-specific visual recognition determiner 26 determines that the driver DR has not visually recognized the notification target. Also, the driver-specific visual recognition determiner 26 outputs visual recognition information indicating that the notification target is located outside of the visual field blockage area to the notifier 28. Thereby, the notifier 28 notifies the driver DR that the notification target (here, the pedestrian H1) is present at a normal notification intensity (step S162).

When it is determined that the notification target is located inside of the visual field blockage area in step S150, the driver-specific visual recognition determiner 26 confirms whether or not the accumulated period of time is greater than or equal to the second prescribed period of time (step S170). When it is confirmed that the accumulated period of time is greater than or equal to the second prescribed period of time in step S170, the driver-specific visual recognition determiner 26 determines that the driver DR has visually recognized the notification target located inside of the visual field blockage area and returns the process to step S100. On the other hand, when it is confirmed that the accumulated period of time is not greater than or equal to the second prescribed period of time in step S170, the driver-specific visual recognition determiner 26 determines that the driver DR has not visually recognized the notification target located inside of the visual field blockage area. Also, the driver-specific visual recognition determiner 26 outputs visual recognition information indicating that the notification target is located inside of the visual field blockage area to the notifier 28. Thereby, the notifier 28 notifies the driver DR that the notification target (here, the pedestrian H1) is present at a notification intensity higher than the normal notification intensity (step S172).

Subsequently, the driver-specific visual recognition determiner 26 updates the accumulated period of time for which the notification target has been in the visual line direction of the driver DR (step S180). Also, the driver-specific visual recognition determiner 26 ends the current process of the present flowchart for the front-view image captured by the front-view camera 10.

### [Example of Notification in Driving Assistance Device]

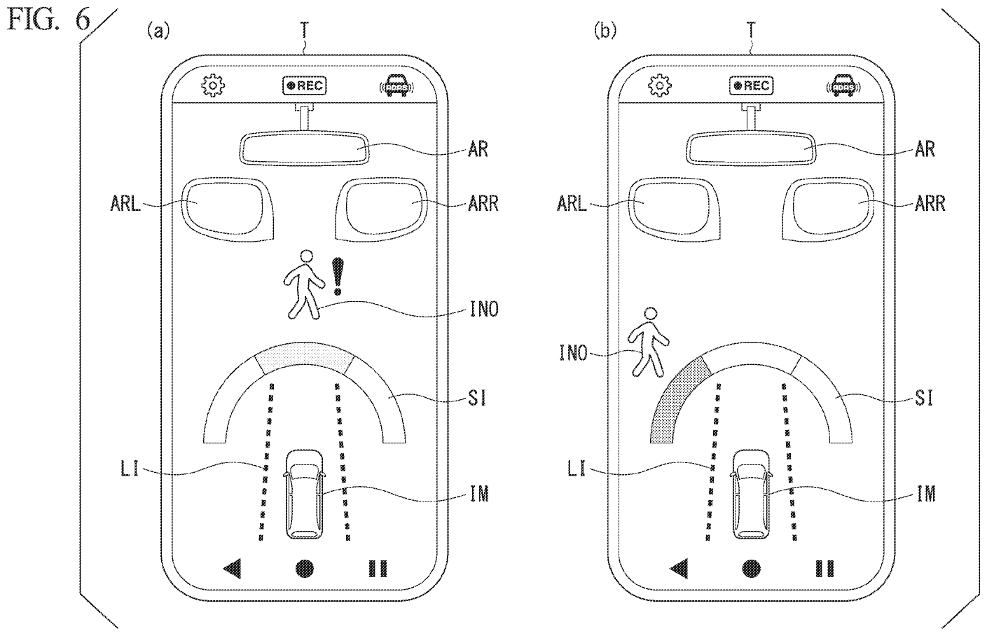

FIG. 6 is a diagram showing an example of a notification image for providing a notification in the driving assistance device 20. In FIG. 6, an example of a notification image for visually notifying the driver DR of the presence of the notification target by causing the display device provided in the terminal device T to display a vehicle icon IM indicating the vehicle V, a traveling lane image LI indicating a recognized traveling lane of the vehicle V, a target presence direction image SI simply indicating a direction in which the notification target is located in front of the vehicle icon IM, and a notification target icon INO indicating the type of notification target is shown.

In the notification image shown in (a) of FIG. 6, the target presence direction image SI on the front side of the vehicle icon IM is highlighted and the notification target icon INO indicating a pedestrian is shown, such that the driver DR is notified that the pedestrian who is likely to cross in front of the vehicle V is present. In the notification image shown in (b) of FIG. 6, the target presence direction image SI on the left side of the vehicle icon IM is highlighted and the notification target icon INO indicating a pedestrian is shown, such that there is a pedestrian on the front left side of the vehicle V and therefore the driver DR is notified that it is necessary to pay attention to entanglement in the case of the left turn.

In (a) of FIG. 6 and (b) of FIG. 6, an example of a notification image including each of a rearview mirror area AR indicating that the target can be visually recognized through the rearview mirror, a right-side mirror area ARR indicating that the target can be visually recognized through the right-side mirror, a left-side mirror area ARL indicating that the target can be visually recognized through the left-side mirror is shown. In each of the rearview mirror area AR, the right-side mirror area ARR, and the left-side mirror area ARL, for example, the target shown in the rear-view image captured by the rear-view camera 12 may be represented. In this case, for example, the notification image generator 282 may generate a notification image by cutting out a target located in each of the rearview mirror area AR, the right-side mirror area ARR, and the left-side mirror area ARL from the rear-view image output by the rear-view camera 12 and superimposing the cut target. For example, the target recognizer 22 recognizes a target located behind the vehicle V on the basis of the rear-view image output by the rear-view camera 12 and the notification image generator 282 may generate a notification image in which the recognized target or information indicating the target is displayed in each of the rearview mirror area AR, the right-side mirror area ARR, and the left-side mirror area ARL on the basis of the target information output by the target recognizer 22.

As described above, according to the driving assistance device 20 of the embodiment, the visual field blockage area setter 262 sets (registers) the visual field blockage area in advance at a corresponding position within the angle of view of the front-view image captured by the front-view camera 10. Also, in the driving assistance device 20 of the embodiment, the visual recognition state of the driver DR for the notification target (target) shown in the front-view image output by the front-view camera 10 is determined on the basis of the face orientation of the driver DR shown in the rear-view image output by the rear-view camera 12, the accumulated period of time for which the notification target (target) has been in the visual line direction, and a threshold value of a prescribed period of time (the first prescribed period of time or the second prescribed period of time) for determining the visual recognition state of the notification target. Also, when it is determined that there is a notification target that cannot be visually recognized by the driver DR or has a low visual recognition level, the driving assistance device 20 of the embodiment notifies the driver DR of the presence of the notification target through the terminal device T. At this time, when the notification target is located inside of the visual field blockage area, the driving assistance device 20 of the embodiment provides a notification of the presence of the notification target at a notification intensity higher than the normal notification intensity when the notification target is located outside of the visual field blockage area. Thereby, the driver DR of the vehicle V to which the driving monitoring device 1 including the driving assistance device 20 of the embodiment is attached can know that there is a notification target (a target) that is likely to be a risk to the continuation of traveling of the vehicle V through the notification from the driving assistance device 20 of the embodiment. Thereby, the driver DR of the vehicle V can perform an operation (driving) of the vehicle V corresponding to the notification target (the target) of which the driver DR is notified and the preparation for the operation (driving) in advance and can continue to travel more safely.

A case where the driver-specific visual recognition determiner 26 sets the prescribed period of time for determining the visual recognition state as the first prescribed period of time or the second prescribed period of time according to whether the notification target is located inside of the visual field blockage area or outside of the visual field blockage area, i.e., determines the visual recognition state according to two prescribed periods of time, in the driving assistance device 20 of the above-described embodiment has been described. However, in the driving assistance device 20, the prescribed period of time for the driver-specific visual recognition determiner 26 to determine the visual recognition state may be set in more periods. For example, the length of the second prescribed period of time may be divided into a plurality of periods by making a change according to the type of notification target. In this case, the notifier 28 may change a notification method for the driver DR according to the type of notification target.

A case where a visual field blockage area is set (registered) by the visual field blockage area setter 262 on the basis of the visual line direction of the driver DR estimated by the visual line direction estimator 24 in the driving assistance device 20 of the above-described embodiment has been described. However, it is also possible to implement functions similar to those of the driving assistance device 20 of the embodiment using an external recognition device such as a camera for monitoring the road in front of the vehicle V, a monitoring camera for observing the driver DR, and the like attached in advance to the vehicle V. In this case, if the face orientation of the driver DR shown in the monitoring camera is associated with the positions and thicknesses (widths) of the left and right front pillars, it is possible to set the visual field blockage area by estimating the position of the head of the driver DR in the visual line direction estimator 24. That is, the visual field blockage area setter 262 can set the visual field blockage area without affixing a mark (for example, a sticker) of a prescribed size to the left and right front pillars at the position of the visual line level of the driver DR or instructing the driver DR to look at the left and right front pillars. Also, in this case, the operation and process of the driving assistance device 20 after the visual field blockage area setter 262 sets (registers) the visual field blockage area are similar to the operation and process of the driving assistance device 20 of the above-described embodiment.

A configuration in which the notifier 28 notifies the driver DR of the presence of the target that cannot be visually recognized by the driver DR (or has a low visual recognition level) through the terminal device T in the driving assistance device 20 of the above-described embodiment has been described. However, the driving monitoring device 1 may have a configuration including, for example, an audio device such as a buzzer or a speaker and a display device such as an LCD. In this case, the notifier 28 may notify the driver DR of the presence of the target that cannot be visually recognized by the driver DR (or has a low visual recognition level) through the notification device such as the audio device, the display device, or the like provided in the driving monitoring device 1 in place of or in addition to the terminal device T. In this case, it is only necessary for the operation and process of the driving assistance device 20 to be equivalent to the operation and process of the driving assistance device 20 of the above-described embodiment.

According to the above-described embodiment, the driving assistance device 20 includes the visual line direction estimator 24 configured to estimate a visual line direction of the driver DR of the vehicle V on the basis of a rear-view image including the driver DR; the target recognizer 22 configured to recognize a target included in a front-view image obtained by capturing the view in front of the vehicle V; the driver-specific visual recognition determiner 26 configured to determine whether or not the target is a notification target that is a target of which the driver DR is notified and determine a visual recognition state indicating whether the driver DR has visually recognized the notification target on the basis of the visual line direction; and the notifier 28 configured to notify the driver DR of the presence of the notification target using a notification device (here, the terminal device T used by the driver DR) when it is determined that the visual recognition state is a visual recognition state in which the driver DR has not visually recognized the notification target, whereby it is possible to determine a notification target (a target) located in a direction in which a visual line direction of the driver DR is blocked and provide a notification of a determination result. Thereby, the driver DR of the vehicle V to which the driving monitoring device 1 including the driving assistance device 20 is attached can know that there is a notification target (a target) that is likely to be a risk to the continuation of traveling of the vehicle V through the notification from the driving assistance device 20. Thereby, the driver DR of the vehicle V can perform an operation (driving) of the vehicle V corresponding to the notified target (the target) or preparation thereof in advance and can continue traveling more safely.

The embodiment described above can be represented as follows.

A driving assistance device including:
a hardware processor; and
a storage device storing a program,
wherein the hardware processor reads and executes the program stored in the storage device to:
estimate a visual line direction of a driver of a vehicle on the basis of a rear-view image including the driver,
recognize a target included in a front-view image obtained by capturing the view in front of the vehicle,
determine whether or not the target is a notification target that is a target of which the driver is notified,
determine a visual recognition state indicating whether or not the driver has visually recognized the notification target on the basis of the visual line direction; and
notify the driver of the presence of the notification target using a notification device when it is determined that the visual recognition state is a visual recognition state in which the driver has not visually recognized the notification target.

Although modes for carrying out the present invention have been described above using embodiments, the present invention is not limited to the embodiments and various modifications and substitutions can also be made without departing from the scope and spirit of the present invention.

What is claimed is:

1. A driving assistance device comprising a processor configured to execute computer-readable instructions to perform:
estimating a visual line direction of a driver of a vehicle based on a rear-view image including the driver;
recognizing a target included in a front-view image obtained by capturing the view in front of the vehicle;
determining whether or not the target is a notification target that is a target of which the driver is notified;
determining a visual recognition state indicating whether or not the driver has visually recognized the notification target based on the visual line direction; and
notifying the driver of the presence of the notification target using a notification device when it is determined that the visual recognition state is a visual recognition state in which the driver has not visually recognized the notification target.

2. The driving assistance device according to claim 1,
wherein, in a state in which a visual field blockage area where a visual field of the driver is blocked by a non-transparent area that is a part of a non-transparent vehicle body provided in the vehicle is preset within an angle of view of the front-view image,
wherein the processor is configured to execute the computer-readable instructions to perform:
determining that the driver has not visually recognized the notification target in a first visual recognition state in which a position where the notification target is located has not been in the visual line direction for a first period of time or longer or a second visual recognition state in which the position where the notification target is located is in a direction of the visual field blockage area and the position where the notification target is located has not been in the visual line direction for a second period of time or longer, the second period of time being longer than the first period of time.

3. The driving assistance device according to claim 2, wherein the visual field blockage area is preset based on a positional relationship between the non-transparent area and the visual line direction when the driver is facing in a direction of the non-transparent area.

4. The driving assistance device according to claim 3, wherein the visual field blockage area is preset based on coordinates indicating a position of a head portion of the driver and coordinates indicating a position of a center of the non-transparent area on a two-dimensional plane at an eye level of the driver.

5. The driving assistance device according to claim 3, wherein the visual field blockage area is preset based on an angle between a visual line reference line indicating a visual line direction when the driver is facing the front and an end of the non-transparent area on a two-dimensional plane at an eye level of the driver.

6. The driving assistance device according to claim 3, wherein the visual field blockage area is preset based on a width of the non-transparent area on a two-dimensional plane at an eye level of the driver.

7. The driving assistance device according to claim 2, wherein the visual field blockage area includes at least an area of a front pillar of the vehicle by which a visual field is blocked in a driving state in which the driver is driving the vehicle.

8. The driving assistance device according to claim 2,
wherein the processor is configured to execute the computer-readable instructions to perform:
notifying the driver of the presence of the notification target by causing the notification device to produce a sound indicating notification content.

9. The driving assistance device according to claim 2,
wherein the processor is configured to execute the computer-readable instructions to perform:
generating a notification image indicating notification content, and
notifying the driver of the presence of the notification target by causing the notification device to display the notification image.

10. The driving assistance device according to claim 2,
wherein the processor is configured to execute the computer-readable instructions to perform:
notifying increases a notification intensity when the driver is notified of the presence of the notification target in the second visual recognition state as compared with the first visual recognition state.

11. The driving assistance device according to claim 1, wherein the notification device is a terminal device used by the driver.

12. A driving assistance method comprising:
estimating, by a computer, a visual line direction of a driver of a vehicle based on a rear-view image including the driver;
recognizing, by the computer, a target included in a front-view image obtained by capturing the view in front of the vehicle;
determining, by the computer, whether or not the target is a notification target that is a target of which the driver is notified;
determining, by the computer, a visual recognition state indicating whether or not the driver has visually recognized the notification target based on the visual line direction; and
notifying, by the computer, the driver of the presence of the notification target using a notification device when it is determined that the visual recognition state is a visual recognition state in which the driver has not visually recognized the notification target.

13. A non-transitory computer-readable storage medium storing a program for causing a computer to:
estimate a visual line direction of a driver of a vehicle based on a rear-view image including the driver,
recognize a target included in a front-view image obtained by capturing the view in front of the vehicle,
determine whether or not the target is a notification target that is a target of which the driver is notified,
determine a visual recognition state indicating whether or not the driver has visually recognized the notification target based on the visual line direction; and
notify the driver of the presence of the notification target using a notification device when it is determined that the visual recognition state is a visual recognition state in which the driver has not visually recognized the notification target.
